(19) United States
(12) Patent Application Publication
(10) Pub. No.: US 2019/0102909 A1
(43) Pub. Date: Apr. 4, 2019

(54) AUTOMATED IDENTIFICATION OF PARTS OF AN ASSEMBLY

(71) Applicant: Siemens Aktiengesellschaft, München (DE)

(72) Inventors: Stefan Kluckner, Rum (AT); Shanhui Sun, Princeton, NJ (US); Kai Ma, West Windsor, NJ (US); Ziyan Wu, Plainsboro, NJ (US); Arun Innanje, Princeton, NJ (US); Jan Ernst, Plainsboro, NJ (US); Terrence Chen, Princeton, NJ (US)

(21) Appl. No.: 16/082,912

(22) PCT Filed: Mar. 9, 2017
(86) PCT No.: PCT/US2017/021474

§ 371 Date: Sep. 6, 2018

Related U.S. Application Data
(60) Provisional application No. 62/306,974, filed on Mar. 11, 2016.

(51) Int. Cl. G06T 7/73; G06K 9/62; G06T 15/10; G06T 17/10; G06F 17/50

(52) U.S. Cl. CPC G06T 7/75; G06T 7/74; G06K 9/6211; G06T 2207/10028; G06T 17/10; G06F 17/5009; G06T 15/10

(57) ABSTRACT

Systems, methods, and computer-readable media are disclosed for automated identification of parts of a parts assembly using image data of the parts assembly and 3D simulated model data of the parts assembly. The 3D simulated model data may be 3D CAD data of the parts assembly. An image of the parts assembly is captured by a mobile device and sent to a back-end server for processing. The back-end server determines a feature representation corresponding to the image and searches a repository to locate a matching feature representation stored in association with a corresponding pose estimation. The matching pose estimation is rendered as an overlay on the image of the parts assembly, thereby enabling automated identification of parts within the image or some user-selected portion of the image.

### CROSS-REFERENCE TO RELATED APPLICATION(S)

This application claims the benefit of U.S. Provisional Application No. 62/306,974 filed on Mar. 11, 2016, the content of which is incorporated herein in its entirety.

### BACKGROUND

A physical assembly may include a large number of constituent parts. During operation, a part within the assembly may fail or otherwise require replacement due to normal wear and tear. For assemblies containing a large number of parts across a range of sizes, identifying a particular part for replacement through manual inspection may be cumbersome. Further, in certain instances, differentiating one part from another may be difficult.

### BRIEF DESCRIPTION OF THE DRAWINGS

The detailed description is set forth with reference to the accompanying drawings. The drawings are provided for purposes of illustration only and merely depict example embodiments of the disclosure. The drawings are provided to facilitate understanding of the disclosure and shall not be deemed to limit the breadth, scope, or applicability of the disclosure. In the drawings, the left-most digit(s) of a reference numeral identifies the drawing in which the reference numeral first appears. The use of the same reference numerals indicates similar, but not necessarily the same or identical components. However, different reference numerals may be used to identify similar components as well. Various embodiments may utilize elements or components other than those illustrated in the drawings, and some elements and/or components may not be present in various embodiments. The use of singular terminology to describe a component or element may, depending on the context, encompass a plural number of such components or elements and vice versa.

FIG. 1 is a schematic diagram illustrating automated part identification using image data of a parts assembly and three-dimensional (3D) simulated model data of the parts assembly in accordance with one or more example embodiments of the disclosure.

FIG. 2 is a process flow diagram of an illustrative method for automated part identification using image data of a parts assembly and 3D simulated model data of the parts assembly in accordance with one or more example embodiments of the disclosure.

FIG. 3 is a process flow diagram of an illustrative method for determining a pose estimation of 3D simulated model data of a parts assembly that matches a feature representation corresponding to an image of the parts assembly in accordance with one or more example embodiments of the disclosure.

FIG. 4 is a process flow diagram of an illustrative method for determining and storing associations between pose estimations of 3D simulated model data of a parts assembly and corresponding feature representations in accordance with one or more example embodiments of the disclosure.

FIG. 5 is a schematic diagram of an illustrative networked architecture in accordance with one or more example embodiments of the disclosure.

### DETAILED DESCRIPTION

### Overview

This disclosure relates to, among other things, devices, servers, systems, methods, computer-readable media, techniques, and methodologies for automated identification of parts of a parts assembly using image data of the parts assembly and 3D simulated model data of the parts assembly. The parts assembly may be any machine assembly containing constituent physical parts. For instance, as a non-limiting example, the parts assembly may be train vehicle composed of over one hundred thousand parts including thousands of unique spare parts.

The 3D simulated model data may be, for example, 3D computer-aided design (CAD) data corresponding to the physical parts assembly. The 3D CAD data may be represented in 3D space using XYZ coordinate systems and may be noise-free. Connections between vertices in the 3D CAD data may be identified using geometric primitives such as triangles or tetrahedrons or more complex 3D representations composing the 3D CAD model. The 3D CAD data may be associated with metadata that may include an identification of the parts of the physical assembly (e.g., part numbers), an identification of the locations of parts within the assembly, and so forth.

In example embodiments of the disclosure, multiple different virtual viewpoints of the 3D simulated model data may be identified. The virtual viewpoints of the 3D simulated model data may be referred to herein as pose estimations and may each represent a unique view of the 3D simulated model of the parts assembly (e.g., the 3D CAD data) from the perspective of a virtual observer. Any number of pose estimations of the 3D simulated model may be identified at any level of granularity. In certain example embodiments, it may be desirable to identify a sufficient number of pose estimations that represent virtual viewpoints of the 3D simulated model of the parts assembly from enough different angles and perspectives of a virtual observer so as to enable identification of any part within the assembly. In certain example embodiments, certain parts in an assembly may be occluded, and thus, may not be visible from certain potential viewpoints (or from any potential viewpoint). Accordingly, it may be necessary to identify enough pose estimations to capture those viewpoints from which an assembly part is visible, when the assembly part is occluded from other viewpoints.

In certain example embodiments, a mapping function or the like may be applied to the pose estimations to obtain a corresponding set of feature representations. Each feature representation may be, for example, a feature vector or other suitable data structure that is representative of a corresponding pose estimation. Each feature representation may indicate the extent to which each feature in a set of features is represented within the corresponding pose estimation. The set of features may be predetermined or may be machine-learned. For example, machine learning techniques may be employed to identify those features that are the most discriminative in identifying any given pose estimation and differentiating it from each other pose estimation. Each feature representation may be unique to a particular pose estimation and may serve as a reduced-dimension representation of the pose estimation. Associations between the set of pose estimations and the corresponding set of feature representations may be stored in a data repository.

In certain example embodiments, a user of a user device may capture an image of a physical parts assembly. The image may be a 2.5D image such as an RBGD image that captures both color information as well as depth information. The user device may send the captured 2.5D image data to one or more back-end servers for further processing. In particular, a back-end server may receive the 2.5D image data from the user device and apply the mapping function to the image data to obtain a corresponding feature representation. The back-end server may then search a data repository using the feature representation obtained from the image data to identify a matching pose estimation. The matching pose estimation may be one that is stored in association with a feature representation that matches the feature representation obtained from the image data within a specified tolerance.

Upon identifying the matching pose estimation, the pose estimation may be rendered as an overlay over the image of the parts assembly. Rendering the pose estimation as an overlay over the assembly image may include rendering the 3D simulated model of the parts assembly (e.g., the 3D CAD data) from a virtual viewpoint that corresponds to an actual viewpoint from which the assembly image was taken. In this manner, the parts of the assembly represented by the rendered 3D CAD data may be aligned with parts of the assembly captured in the image with respect to their relative orientations and locations within the assembly.

In certain example embodiments, parts identification data/metadata may be displayed in association with the rendering of the pose estimation. For example, each part present within the pose estimation may be identified by a part identification number. Each part identification number may be displayed on the user device in association with the corresponding part on the rendered pose estimation. Thus, as a result of the pose estimation being rendered as an overlay on the image of the parts assembly, a part identification number may be effectively displayed in association with each actual part of the assembly within the assembly image. In other example embodiments, a parts list may be presented that identifies each part present in the rendered pose estimation, and thus, each part observable in the assembly image. Various other metadata may also be presented such as, for example, cost information, supplier information, or the like.

In certain example embodiments, a user of the user device may be able to select a region of the assembly image via of user interface (UI) of the user device. For example, the UI may enable the user to provide touch input, stylus input, or the like to a display of the user device to generate a bounding box around some portion of the assembly image. The user may draw the bounding box around one or more parts within the assembly image. The back-end server may receive an indication of the user selection and identify the one or more assembly parts contained in the region of the assembly image bounded by the bounding box. The back-end server may identify the assembly part(s) using the pose estimation that is rendered as an overlay over the assembly image. Upon identification of the assembly part(s) within the selected portion of the assembly image, any of the parts data/metadata described earlier may be presented to the user. Further, in certain example embodiments, an application executing on the user device may enable automated ordering of parts identified within the assembly.

### Illustrative Embodiments

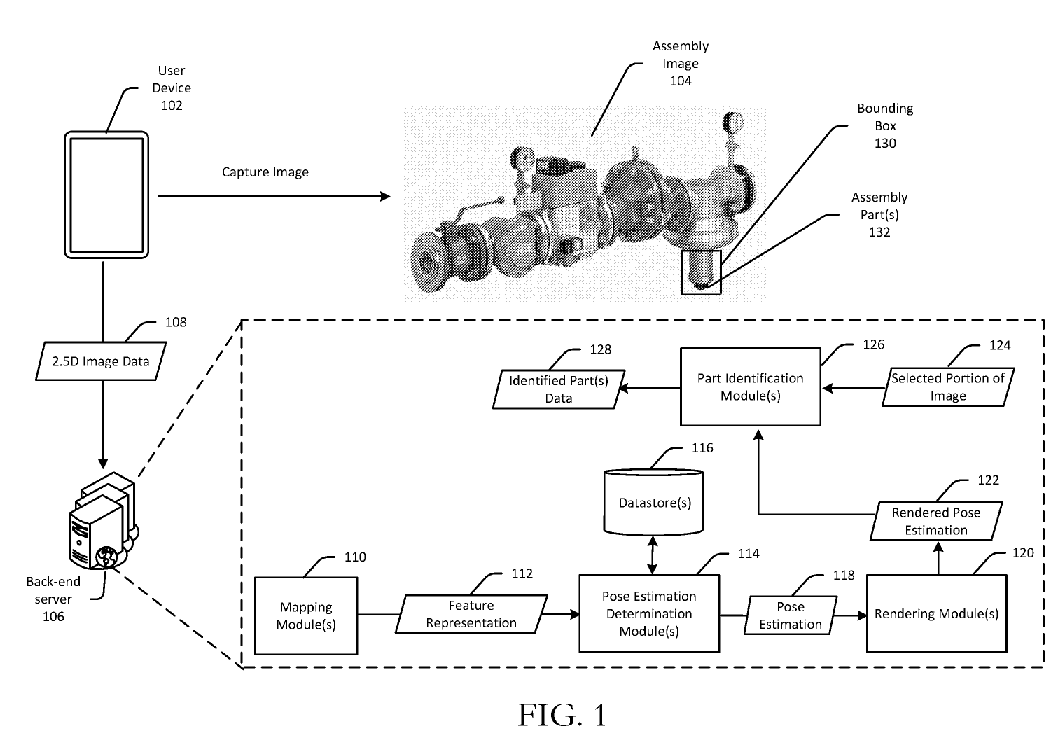

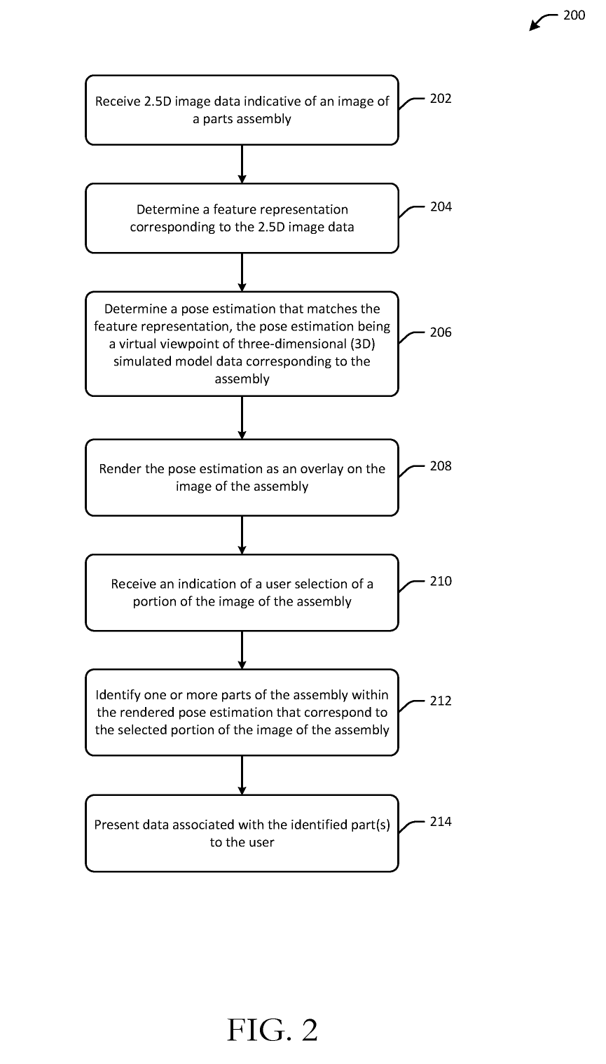

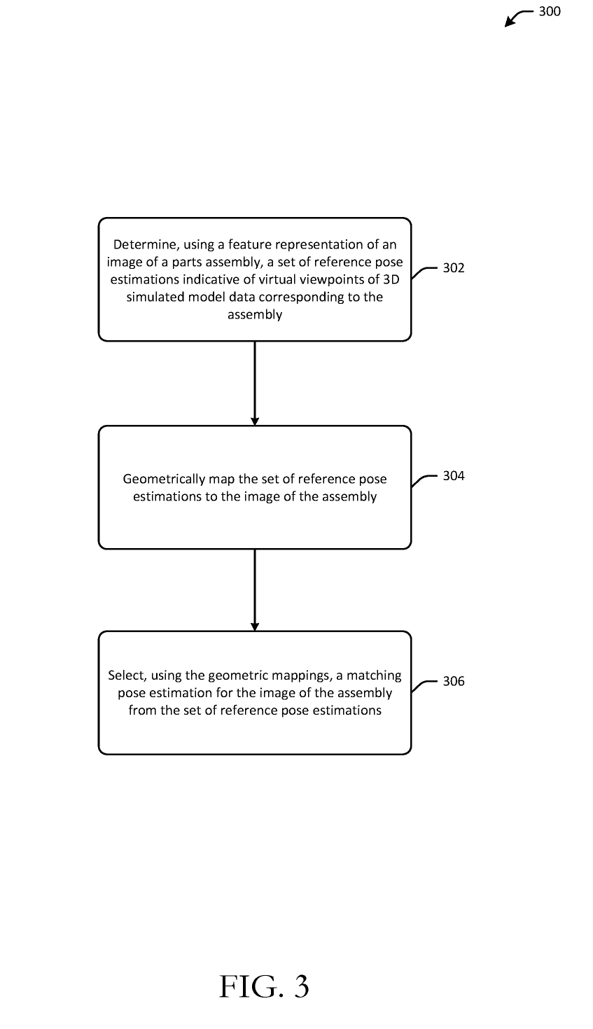

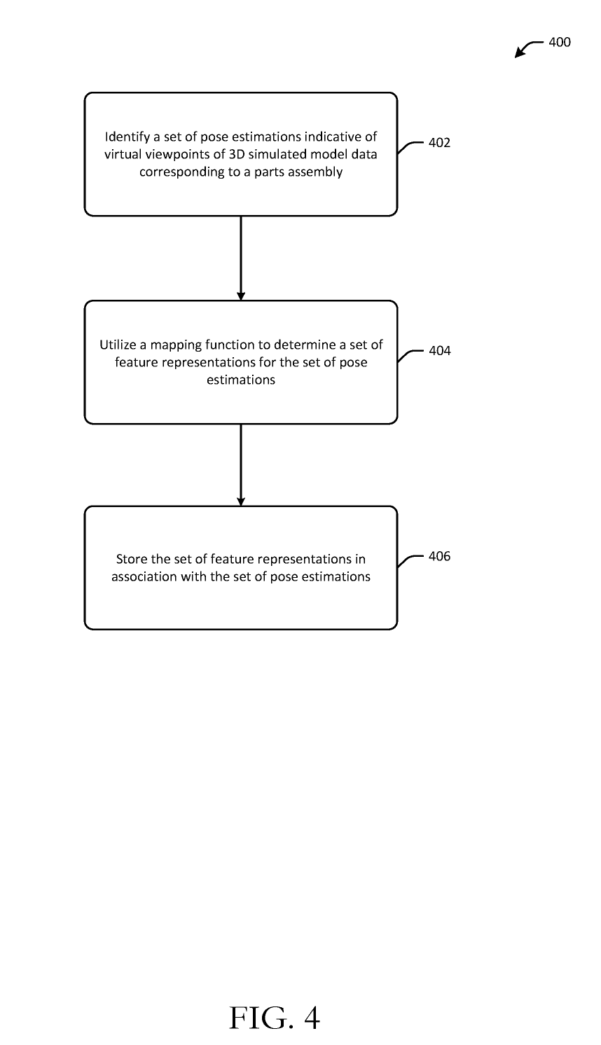

FIG. 1 is a schematic diagram illustrating automated part identification using image data of a parts assembly and 3D simulated model data of the parts assembly. FIG. 2 is a process flow diagram of an illustrative method 200 for automated part identification using image data of a parts assembly and 3D simulated model data of the parts assembly. FIG. 3 is a process flow diagram of an illustrative method 300 for determining a pose estimation of 3D simulated model data of a parts assembly that matches a feature representation corresponding to an image of the parts assembly. FIG. 4 is a process flow diagram of an illustrative method 400 for determining and storing associations between pose estimations of 3D simulated model data of a parts assembly and corresponding feature representations. Each of FIGS. 2-4 will be described in conjunction with FIG. 1 hereinafter.

Each operation of any of the methods 200-400 may be performed by one or more components that may be implemented in any combination of hardware, software, and/or firmware. In certain example embodiments, one or more of these component(s) may be implemented, at least in part, as software and/or firmware that contains or is a collection of one or more program modules that include computer-executable instructions that when executed by a processing circuit cause one or more operations to be performed. A system or device described herein as being configured to implement example embodiments of the invention may include one or more processing circuits, each of which may include one or more processing units or nodes. Computer-executable instructions may include computer-executable program code that when executed by a processing unit may cause input data contained in or referenced by the computer-executable program code to be accessed and processed to yield output data.

Referring first to FIG. 1 in conjunction with FIG. 2, at block 202 of the method 200, a back-end server may receive image data 108 from a user device 102. The image data 108 may be 2.5D image data representative of a captured image 104 of a parts assembly. The 2.5D image data 108 may include both color information and depth information, and thus, may provide a 3D perspective view of the parts assembly from the point-of-view of an observer. In certain example embodiments, the user device 102 may a mobile device such as a smartphone, a tablet, a wearable computing device, or the like. More generally, the user device 102 may be any device that includes one or more cameras or other sensors configured to capture image data.

The user device 102 may be provided with one or more RGBD sensors configured to generate image data that includes both color information and depth information. The depth information may be provided using any suitable depth measurement technology including, but not limited to, time-of-flight technologies such as light detection and ranging (LIDAR). Each pixel in the 2.5D image data 108 may correspond to a depth measurement. Using camera parameters of the user device 102, the 2.5D image data 108 may be converted to a 3D point cloud with the camera center at the origin. The depth information in the 2.5D image data 108 may be aligned with the RGB information such that a user can utilize the RGB assembly image 104 to select specific parts of the assembly.

At block 204 of the method 200, computer-executable instructions of one or more mapping modules 110 may be executed to determine a feature representation 112 corresponding to the 2.5D image data 108. More specifically, the mapping module(s) 110 may receive the 2.5D image data 108 from the user device 102 and apply a mapping function or the like to the image data 108 to obtain the corresponding feature representation 112. The feature representation 112 may be a feature vector or the like that has reduced dimensionality (e.g., number of features) as compared to the image data 108 itself, but which can be used to uniquely identify the assembly image 104 and the particular perspective from which it is captured.

At block 206 of the method 200, computer-executable instructions of one or more pose estimation determination modules 114 may be executed to determine a pose estimation 118 that matches the feature representation 112, where the matching pose estimation 118 represents a virtual viewpoint of 3D simulated model data corresponding to the parts assembly. More specifically, the pose estimation determination module(s) 114 may search one or more datastores 116 using the feature representation 112 obtained from the image data 108 to identify the matching pose estimation 118. The matching pose estimation 118 may be one that is stored in the datastore(s) 116 in association with a feature representation that matches the feature representation 112 obtained from the image data 108 within a specified tolerance.

The datastore(s) 116 may be populated with data that associates feature representations with corresponding pose estimations using the method 400 of FIG. 4. Referring now to FIG. 4, at block 402 of the method 400, computer-executable instructions of the pose estimation determination module(s) 114 may be executed to identify a set of pose estimations indicative of virtual viewpoints of 3D simulated model data corresponding to a parts assembly. As previously noted, the 3D simulated model data may be 3D CAD data of the parts assembly, and each virtual viewpoint embodied in a pose estimation may reflect a particular viewpoint of the 3D CAD model of the parts assembly from a particular perspective of a virtual observer.

In certain example embodiments, each pose estimation may be a synthetic rendering of 3D CAD data for a parts assembly that represents a virtual viewpoint of the 3D CAD data that corresponds to a potential viewpoint from which a user may observe the actual physical assembly. In certain example embodiments, each pose estimation may be a synthetically created 2.5D image generated from 3D CAD data by projecting the 3D CAD data onto a defined image plane. Each pixel in such a synthetically generated 2.5D image may correspond to a depth measurement that together with camera parameters can be used to recover the mapped and visible surface of the parts assembly. Further, each pose estimation may include sufficient context information to permit identification of any given part of the assembly. The context information may include 2.5D image data for neighboring portions of the assembly around any given part of the assembly.

The set of pose estimations identified at block 402 of the method 400 (e.g., the synthetic 2.5D images) may be used to create a representative dataset that is composed of potential virtual viewpoints of the 3D CAD model of the parts assembly that, in turn, can be used for identifying specific parts within the parts assembly. In certain example embodiments, the virtual viewpoints represented by the pose estimations may need to satisfy limitations of 2.5D sensors present in the user device 102 (e.g., sensor ranges) so that the virtual viewpoints reflect the actual viewpoints from which the user is able to observe the actual parts assembly.

At block 404 of the method 400, computer-executable instructions of the mapping module(s) 110 may be executed to utilize a mapping function to determine a set of feature representations for the set of pose estimations. More specifically, the mapping module(s) 110 may apply the mapping function to each pose estimation to obtain a corresponding feature representation. Then at block 406 of the method 400, the datastore(s) 116 may be populated with data that stores the set of feature representations in association with the set of pose estimations to which they correspond. For example, each pose estimation may be stored in association with its corresponding feature representation. In this manner, a database of feature representation and pose estimation pairings may be constructed that can be accessed to locate a pose estimation that corresponds to the assembly image 104 based on a correspondence between their respective feature representations.

Referring again to block 206 of the method 200, the matching pose estimation 118 may be determined using, for example, the illustrative method 300 depicted in FIG. 3. Referring now to FIG. 3, at block 302 of the method 300, computer-executable instructions of the pose estimation determination module(s) 114 may be executed to determine, using the feature representation 112 of the assembly image 104, a set of reference pose estimations indicative of virtual viewpoints of 3D simulated model data corresponding to the parts assembly. The set of reference pose estimations may be those pose estimations stored in the datastore(s) 116 in association with corresponding feature representations that deviate from the feature representation 112 by not more than a threshold value. In other words, the set of reference pose estimations may be those having corresponding feature representations that are within a specified tolerance of the feature representation 112.

At block 304 of the method 300, computer-executable instructions of the pose estimation determination module(s) 114 may be executed to geometrically map the set of reference pose estimations to the assembly image 104. Then, at block 306 of the method 300, computer-executable instructions of the pose estimation module(s) 114 may be executed to select, using the geometric mappings, the matching pose estimation 118 from the set of reference pose estimations. More specifically, each of the reference pose estimations may be geometrically mapped to the assembly image 104 contained in the 2.5D image data 108. The best matching pose estimation 118 may then be selected from the set of reference pose estimations using, for example, a 3D rigid registration method such as iterative closest points (ICP).

Referring again to FIG. 2, at block 208 of the method 200, computer-executable instructions of one or more rendering modules 120 may be executed to render the matching pose estimation 118 as an overlay on the assembly image 104. Rendering the pose estimation 118 as an overlay over the assembly image 104 may include rendering the 3D simulated model of the parts assembly (e.g., the 3D CAD data) from a virtual viewpoint that corresponds to an actual viewpoint from which the assembly image 104 was taken. In this manner, the parts of the assembly represented by the rendered 3D CAD data may be aligned with parts of the assembly captured in the image 104 with respect to their relative orientations and locations within the assembly.

At block 210 of the method 200, the back-end server 106 may receive an indication 124 of a user selection of a portion of the assembly image 104. More specifically, one or more part identification modules 126 may receive the indication 124 of the selected portion of the assembly image 104 as an input. The part identification module(s) 126 may also receive a rendered pose estimation 122 (e.g., the rendering of the pose estimation 118 as an overlay over the assembly image 104) as another input. For instance, in certain example embodiments, a user of the user device 102 may be able to select a region of the assembly image 104 via a UI of the user device 102. For example, the UI may enable the user to provide touch input, stylus input, or the like to a display of the user device 102 to generate a bounding box 130 around some portion of the assembly image 104. The user may draw the bounding box 130 around one or more parts 132 within the assembly image 104.

At block 212, the part identification module(s) 126 may be executed to identify, based on the selected portion 124 of the image 104 and the rendered pose estimation 122, one or more assembly parts within the rendered pose estimation 122, and thus one or more assembly parts 132 within the assembly image 104, that correspond to the selected portion 124 of the image 104. In certain example embodiments, context information present within the rendered pose estimation 122 may be used to assist identifying the assembly part(s) 132. Further, the part identification module(s) 126 may be configured to analyze the entire rendered pose estimation 122, but may only identified those assembly part(s) 132 within the selected portion 124 of the image 104.

Upon identification of the assembly part(s) 132 within the selected portion 124 of the assembly image 104, data/metadata 128 associated with the identified part(s) 132 may be presented to a user of the user device 102 at block 214 of the method 200. In certain example embodiments, the data/metadata 128 may be displayed in association with the rendered pose estimation 122. For example, each part present within the selected portion 124 of the image 104 may be identified by a part identification number. Each part identification number may be displayed on the user device 102 in association with the corresponding part on the rendered pose estimation 122. Thus, as a result of the pose estimation 118 being rendered as an overlay on the image 104 of the parts assembly, a part identification number may be effectively displayed in association with each actual part of the assembly within the selected portion 124 of the assembly image 104. In other example embodiments, a parts list may be presented that identifies each part present in the rendered pose estimation 122, and thus, each part observable in the assembly image 104 or each part present in the selected portion 124 of the image 104. Various other metadata 128 may also be presented such as, for example, cost information, supplier information, or the like.

In certain example embodiments, an application executing on the user device 102 may enable automated ordering of parts identified within the assembly. For example, after being presented with the data/metadata 128 associated with the identified assembly part(s) 132 within the bounding box 130, the user may be able to select/highlight a particular part to initiate an order for the part, view additional information relating to the part, or the like. In certain example embodiments, the parts of the assembly may be assumed to be uniquely identifiable and may be color-coded or otherwise labeled with indicia that distinguishes one part from another. Further, in certain example embodiments, hierarchical information from the 3D CAD data may enable automated segmentation of parts in the set of pose estimations, and may further enable improved part selection capabilities for, as an example, initiating an order. For example, if the user selects a particular part of the assembly, other part(s) of the assembly that are dependent on the selected part may be identified using the hierarchical information, and an indication of such dependent part(s) may be presented to the user to enable selection of one or more of the dependent parts for further processing (e.g., initiating an order).

In addition, example embodiments of the disclosure may be employed in connection with augmented reality (AR) systems. For example, a pose estimation that matches a viewpoint of a user observing a physical parts assembly through an AR wearable device may be rendered as an overlay within the AR environment. The user may then interact with the overlay to select/highlight portions of the parts assembly to enable automated identification of part(s) of the assembly using the rendered pose estimation.

Example embodiments of the disclosure include or yield various technical features, technical effects, and/or improvements to technology. For instance, example embodiments of the disclosure yield the technical effect of automated identification of parts within an image of assembly using 3D simulated model data corresponding to the assembly. This technical effect is achieved, at least in part, by the technical features of identifying a set of pose estimations that reflect virtual viewpoints of the 3D simulated model of the assembly that correspond to actual potential viewpoints of the assembly, and determining feature representations that correspond to the pose estimations and that can be used to identify a pose estimation that matches the viewpoint of an image of the assembly. The matching pose estimation can be rendered as an overlay on the image of the assembly to enable identification of part(s) presented within the assembly image such as, for example, part(s) present within a user-selected portion of the assembly image. The above-mentioned technical features and their corresponding technical effect constitute an improvement to the functioning of a computer by enabling use of 3D simulated model data (e.g., 3D CAD data of an assembly) to perform automated part identification, thereby obviating the need to generate multiple images of the assembly from multiple viewpoints, as is required in connection with conventional part identification technologies. It should be appreciated that the above examples of technical features, technical effects, and improvements to technology of example embodiments of the disclosure are merely illustrative and not exhaustive.

One or more illustrative embodiments of the disclosure have been described above. The above-described embodiments are merely illustrative of the scope of this disclosure and are not intended to be limiting in any way. Accordingly, variations, modifications, and equivalents of embodiments disclosed herein are also within the scope of this disclosure. The above-described embodiments and additional and/or alternative embodiments of the disclosure will be described in detail hereinafter through reference to the accompanying drawings.

### Illustrative Networked Architecture

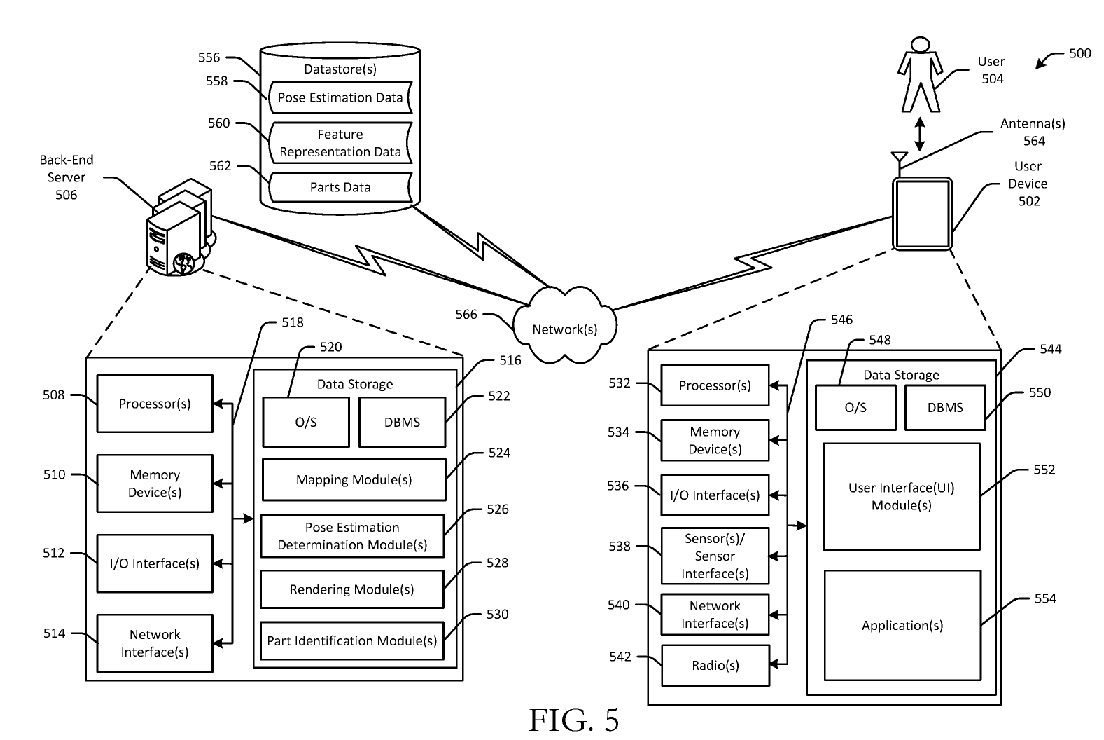

FIG. 5 is a schematic diagram of an illustrative networked architecture 500 in accordance with one or more example embodiments of the disclosure. The networked architecture 500 may include one or more user devices 502, each of which may be utilized by a corresponding user 504. The networked architecture 500 may further include one or more back-end servers 506 and one or more datastores 556. The user server 506 may be an illustrative configuration of the user device 102. Similarly, the back-end server 506 may be an illustrative configuration of the back-end server 106. While multiple user devices 502 and/or multiple back-end servers 506 may form part of the networked architecture 500, these components will be described in the singular hereinafter for ease of explanation. However, it should be appreciated that any functionality described in connection with the back-end server 506 may be distributed among multiple back-end servers 506. Similarly, any functionality described in connection with the user server 506 may be distributed among multiple user devices 502 and/or between a user server 506 and one or more back-end servers 506.

The user server 506 and the back-end server 506 may be configured to communicate via one or more networks 566 which may include, but are not limited to, any one or more different types of communications networks such as, for example, cable networks, public networks (e.g., the Internet), private networks (e.g., frame-relay networks), wireless networks, cellular networks, telephone networks (e.g., a public switched telephone network), or any other suitable private or public packet-switched or circuit-switched networks. Further, the network(s) 566 may have any suitable communication range associated therewith and may include, for example, global networks (e.g., the Internet), metropolitan area networks (MANs), wide area networks (WANs), local area networks (LANs), or personal area networks (PANs). In addition, the network(s) 566 may include communication links and associated networking devices (e.g., link-layer switches, routers, etc.) for transmitting network traffic over any suitable type of medium including, but not limited to, coaxial cable, twisted-pair wire (e.g., twisted-pair copper wire), optical fiber, a hybrid fiber-coaxial (HFC) medium, a microwave medium, a radio frequency communication medium, a satellite communication medium, or any combination thereof.

In an illustrative configuration, the back-end server 506 may include one or more processors (processor(s)) 508, one or more memory devices 510 (generically referred to herein as memory 510), one or more input/output (“I/O”) interface(s) 512, one or more network interfaces 514, and data storage 516. The back-end server 506 may further include one or more buses 518 that functionally couple various components of the server 506. These various components will be described in more detail hereinafter.

The bus(es) 518 may include at least one of a system bus, a memory bus, an address bus, or a message bus, and may permit exchange of information (e.g., data (including computer-executable code), signaling, etc.) between various components of the server 506. The bus(es) 518 may include, without limitation, a memory bus or a memory controller, a peripheral bus, an accelerated graphics port, and so forth. The bus(es) 518 may be associated with any suitable bus architecture including, without limitation, an Industry Standard Architecture (ISA), a Micro Channel Architecture (MCA), an Enhanced ISA (EISA), a Video Electronics Standards Association (VESA) architecture, an Accelerated Graphics Port (AGP) architecture, a Peripheral Component Interconnects (PCI) architecture, a PCI-Express architecture, a Personal Computer Memory Card International Association (PCMCIA) architecture, a Universal Serial Bus (USB) architecture, and so forth.

The memory 510 of the server 506 may include volatile memory (memory that maintains its state when supplied with power) such as random access memory (RAM) and/or non-volatile memory (memory that maintains its state even when not supplied with power) such as read-only memory (ROM), flash memory, ferroelectric RAM (FRAM), and so forth. Persistent data storage, as that term is used herein, may include non-volatile memory. In certain example embodiments, volatile memory may enable faster read/write access than non-volatile memory. However, in certain other example embodiments, certain types of non-volatile memory (e.g., FRAM) may enable faster read/write access than certain types of volatile memory.

In various implementations, the memory 510 may include multiple different types of memory such as various types of static random access memory (SRAM), various types of dynamic random access memory (DRAM), various types of unalterable ROM, and/or writeable variants of ROM such as electrically erasable programmable read-only memory (EEPROM), flash memory, and so forth. The memory 510 may include main memory as well as various forms of cache memory such as instruction cache(s), data cache(s), translation lookaside buffer(s) (TLBs), and so forth. Further, cache memory such as a data cache may be a multi-level cache organized as a hierarchy of one or more cache levels (L1, L2, etc.).

The data storage 516 may include removable storage and/or non-removable storage including, but not limited to, magnetic storage, optical disk storage, and/or tape storage. The data storage 516 may provide non-volatile storage of computer-executable instructions and other data. The memory 510 and the data storage 516, removable and/or non-removable, are examples of computer-readable storage media (CRSM) as that term is used herein.

The data storage 516 may store computer-executable code, instructions, or the like that may be loadable into the memory 510 and executable by the processor(s) 508 to cause the processor(s) 508 to perform or initiate various operations. The data storage 516 may additionally store data that may be copied to memory 510 for use by the processor(s) 508 during the execution of the computer-executable instructions. Moreover, output data generated as a result of execution of the computer-executable instructions by the processor(s) 508 may be stored initially in memory 510, and may ultimately be copied to data storage 516 for non-volatile storage.

More specifically, the data storage 516 may store one or more operating systems (O/S) 520; one or more database management systems (DBMS) 522; and one or more program modules, applications, engines, computer-executable code, scripts, or the like such as, for example, one or more mapping modules 524, one or more pose estimation determination modules 526, one or more rendering modules 528, and one or more part identification modules 530. Any of the components depicted as being stored in data storage 516 may include any combination of software, firmware, and/or hardware. The software and/or firmware may include computer-executable code, instructions, or the like that may be loaded into the memory 510 for execution by one or more of the processor(s) 508 to perform any of the operations described earlier in connection with correspondingly named modules.

The data storage 516 may further store various types of data utilized by components of the server 506 such as, for example, any of the data depicted as being stored in the datastore(s) 556. Any data stored in the data storage 516 may be loaded into the memory 510 for use by the processor(s) 508 in executing computer-executable code. In addition, any data stored in the datastore(s) 556 may be accessed via the DBMS 522 and loaded in the memory 510 for use by the processor(s) 508 in executing computer-executable code.

The processor(s) 508 may be configured to access the memory 510 and execute computer-executable instructions loaded therein. For example, the processor(s) 508 may be configured to execute computer-executable instructions of the various program modules, applications, engines, or the like of the server 506 to cause or facilitate various operations to be performed in accordance with one or more embodiments of the disclosure. The processor(s) 508 may include any suitable processing unit capable of accepting data as input, processing the input data in accordance with stored computer-executable instructions, and generating output data. The processor(s) 508 may include any type of suitable processing unit including, but not limited to, a central processing unit, a microprocessor, a Reduced Instruction Set Computer (RISC) microprocessor, a Complex Instruction Set Computer (CISC) microprocessor, a microcontroller, an Application Specific Integrated Circuit (ASIC), a Field-Programmable Gate Array (FPGA), a System-on-a-Chip (SoC), a digital signal processor (DSP), and so forth. Further, the processor(s) 508 may have any suitable microarchitecture design that includes any number of constituent components such as, for example, registers, multiplexers, arithmetic logic units, cache controllers for controlling read/write operations to cache memory, branch predictors, or the like. The microarchitecture design of the processor(s) 508 may be capable of supporting any of a variety of instruction sets.

Referring now to other illustrative components depicted as being stored in the data storage 516, the O/S 520 may be loaded from the data storage 516 into the memory 510 and may provide an interface between other application software executing on the server 506 and hardware resources of the server 506. More specifically, the O/S 520 may include a set of computer-executable instructions for managing hardware resources of the server 506 and for providing common services to other application programs (e.g., managing memory allocation among various application programs). In certain example embodiments, the O/S 520 may control execution of one or more of the program modules depicted as being stored in the data storage 516. The O/S 520 may include any operating system now known or which may be developed in the future including, but not limited to, any server operating system, any mainframe operating system, or any other proprietary or non-proprietary operating system.

The DBMS 522 may be loaded into the memory 510 and may support functionality for accessing, retrieving, storing, and/or manipulating data stored in the memory 510 and/or data stored in the data storage 516. The DBMS 522 may use any of a variety of database models (e.g., relational model, object model, etc.) and may support any of a variety of query languages. The DBMS 522 may access data represented in one or more data schemas and stored in any suitable data repository.

The datastore(s) 556 may include, but are not limited to, databases (e.g., relational, object-oriented, etc.), file systems, flat files, distributed datastores in which data is stored on more than one node of a computer network, peer-to-peer network datastores, or the like. The datastore(s) 556 may store various types of data such as, for example, pose estimation data 558, feature representation data 560, and parts data 562.

Referring now to other illustrative components of the server 506, the input/output (I/O) interface(s) 512 may facilitate the receipt of input information by the server 506 from one or more I/O devices as well as the output of information from the server 506 to the one or more I/O devices. The I/O devices may include any of a variety of components such as a display or display screen having a touch surface or touchscreen; an audio output device for producing sound, such as a speaker; an audio capture device, such as a microphone; an image and/or video capture device, such as a camera; a haptic unit; and so forth. Any of these components may be integrated into the server 506 or may be separate. The I/O devices may further include, for example, any number of peripheral devices such as data storage devices, printing devices, and so forth.

The I/O interface(s) 512 may also include an interface for an external peripheral device connection such as universal serial bus (USB), FireWire, Thunderbolt, Ethernet port or other connection protocol that may connect to one or more networks. The I/O interface(s) 512 may also include a connection to one or more antennas to connect to one or more networks via a wireless local area network (WLAN) (such as Wi-Fi) radio, Bluetooth, and/or a wireless network radio, such as a radio capable of communication with a wireless communication network such as a Long Term Evolution (LTE) network, WiMAX network, 3G network, etc.

The server 506 may further include one or more network interfaces 514 via which the server 506 may communicate with any of a variety of other systems, platforms, networks, devices, and so forth. The network interface(s) 514 may enable communication, for example, with the user device 502 and/or the datastore(s) 556 via the network(s) 514.

Referring now to the user device 502, in an illustrative configuration, the user device 502 may include one or more processors (processor(s)) 532, one or more memory devices 534 (generically referred to herein as memory 534), one or more input/output (“I/O”) interface(s) 536, one or more sensors or sensor interfaces 538, one or more network interfaces 540, one or more radios 542, and data storage 544. The user device 502 may further include one or more buses 546 that functionally couple various components of the user device 502.

The bus(es) 546 may include any of the types of bus(es) or bus architectures described in reference to the bus(es) 518. Further, the processor(s) 532 may include any of the types of processors described in reference to the processor(s) 508; the memory 534 may include any of the types of memory described in reference to the memory 510; the data storage 544 may include any of the types of data storage described in reference to the data storage 516; the I/O interface(s) 536 may include any of the types of I/O interfaces described in reference to the I/O interface(s) 512; and the network interface(s) 540 may include any of the types of network interfaces described in reference to the network interface(s) 514. The network interface(s) 540 may enable network communication with a back-end server 506 via the network(s) 566.

The data storage 544 may store one or more operating systems (O/S) 548; one or more database management systems (DBMS) 550; and one or more program modules, applications, engines, computer-executable code, scripts, or the like such as, for example, one or more UI modules 552 and one or more applications 554. The O/S 548 may include any of the types of operating systems described in reference to the O/S 520 and the DBMS 550 may include any of the types of database management systems described in reference to the DBMS 522. Any of the components depicted as being stored in data storage 544 may include any combination of software, firmware, and/or hardware. The software and/or firmware may include computer-executable code, instructions, or the like that may be loaded into the memory 534 for execution by one or more of the processor(s) 532.

In certain example embodiments, the application(s) 554 may include a camera application executable on the user device 502 that enables capturing 2.5D image data. The application(s) 554 may further include an application that enables a user 504 of the user device 502 to capture an image of a parts assembly and initiate automated identification and ordering of parts of the assembly. For instances, the UI module(s) 552 may provide a UI via which the user 504 can select a portion of an image of a parts assembly and receive data/metadata associated with parts identified within the selected portion of the image.

The user device 502 may further include one or more antennas 564 that may include, without limitation, a cellular antenna for transmitting or receiving signals to/from a cellular network infrastructure, an antenna for transmitting or receiving Wi-Fi signals to/from an access point (AP), a Global Navigation Satellite System (GNSS) antenna for receiving GNSS signals from a GNSS satellite, a Bluetooth antenna for transmitting or receiving Bluetooth signals, a Near Field Communication (NFC) antenna for transmitting or receiving NFC signals, and so forth.

The antenna(s) 564 may include any suitable type of antenna depending, for example, on the communications protocols used to transmit or receive signals via the antenna(s) 564. Non-limiting examples of suitable antennas may include directional antennas, non-directional antennas, dipole antennas, folded dipole antennas, patch antennas, multiple-input multiple-output (MIMO) antennas, or the like. The antenna(s) 564 may be communicatively coupled to one or more radio components 542 to which or from which signals may be transmitted or received.

As previously described, the antenna(s) 564 may include a cellular antenna configured to transmit or receive signals in accordance with established standards and protocols, such as Global System for Mobile Communications (GSM), 3G standards (e.g., Universal Mobile Telecommunications System (UMTS), Wideband Code Division Multiple Access (W-CDMA), CDMA2000, etc.), 4G standards (e.g., Long-Term Evolution (LTE), WiMax, etc.), direct satellite communications, or the like.

The antenna(s) 564 may additionally, or alternatively, include a Wi-Fi antenna configured to transmit or receive signals in accordance with established standards and protocols, such as the IEEE 802.11 family of standards, including via 2.4 GHz channels (e.g. 802.11b, 802.11g, 802.11n), 5 GHz channels (e.g. 802.11n, 802.11ac), or 60 GHZ channels (e.g. 802.11ad). In alternative example embodiments, the antenna(s) 576 may be configured to transmit or receive radio frequency signals within any suitable frequency range forming part of the unlicensed portion of the radio spectrum.

The antenna(s) 564 may additionally, or alternatively, include a GNSS antenna configured to receive GNSS signals from three or more GNSS satellites carrying time-position information to triangulate a position therefrom. Such a GNSS antenna may be configured to receive GNSS signals from any current or planned GNSS such as, for example, the Global Positioning System (GPS), the GLONASS System, the Compass Navigation System, the Galileo System, or the Indian Regional Navigational System.

The radio(s) 542 may include any suitable radio component(s) for—in cooperation with the antenna(s) 564—transmitting or receiving radio frequency (RF) signals in the bandwidth and/or channels corresponding to the communications protocols utilized by the user device 502 to communicate with other devices. The radio(s) 542 may include hardware, software, and/or firmware for modulating, transmitting, or receiving—potentially in cooperation with any of antenna(s) 564—communications signals according to any of the communications protocols discussed above including, but not limited to, one or more Bluetooth communication protocols, one or more Wi-Fi and/or Wi-Fi direct protocols, as standardized by the IEEE 802.11 standards, one or more non-Wi-Fi protocols, or one or more cellular communications protocols or standards. The radio(s) 542 may further include hardware, firmware, or software for receiving GNSS signals. The radio(s) 542 may include any known receiver and baseband suitable for communicating via the communications protocols utilized by the user device 502. The radio(s) 542 may further include a low noise amplifier (LNA), additional signal amplifiers, an analog-to-digital (A/D) converter, one or more buffers, a digital baseband, or the like.

The sensor(s)/sensor interface(s) 538 may include or may be capable of interfacing with any suitable type of sensing device such as, for example, inertial sensors, force sensors, thermal sensors, optical sensors, time-of-flight sensors, and so forth. Example types of inertial sensors may include accelerometers (e.g., MEMS-based accelerometers), gyroscopes, and so forth.

It should be appreciated that the program modules, applications, computer-executable instructions, code, or the like depicted in FIG. 5 as being stored in the data storage 516 and/or the data storage 544 are merely illustrative and not exhaustive and that processing described as being supported by any particular module may alternatively be distributed across multiple modules or performed by a different module. In addition, various program module(s), script(s), plug-in(s), Application Programming Interface(s) (API(s)), or any other suitable computer-executable code hosted locally on the server 506, the user device 502, and/or hosted on other computing device(s) accessible via one or more of the network(s) 566, may be provided to support functionality provided by the program modules, applications, or computer-executable code depicted in FIG. 5 and/or additional or alternate functionality. Further, functionality may be modularized differently such that processing described as being supported collectively by the collection of program modules depicted in FIG. 5 may be performed by a fewer or greater number of modules, or functionality described as being supported by any particular module may be supported, at least in part, by another module. In addition, program modules that support the functionality described herein may form part of one or more applications executable across any number of systems or devices in accordance with any suitable computing model such as, for example, a client-server model, a peer-to-peer model, and so forth. In addition, any of the functionality described as being supported by any of the program modules depicted in FIG. 5 may be implemented, at least partially, in hardware and/or firmware across any number of devices.

It should further be appreciated that the server 506 and/or the user device 502 may include alternate and/or additional hardware, software, or firmware components beyond those described or depicted without departing from the scope of the disclosure. More particularly, it should be appreciated that software, firmware, or hardware components depicted as forming part of the server 506 and/or the user device 502 are merely illustrative and that some components may not be present or additional components may be provided in various embodiments. While various illustrative program modules have been depicted and described as software modules stored in data storage 516 and/or the data storage 544, it should be appreciated that functionality described as being supported by the program modules may be enabled by any combination of hardware, software, and/or firmware. It should further be appreciated that each of the above-mentioned modules may, in various embodiments, represent a logical partitioning of supported functionality. This logical partitioning is depicted for ease of explanation of the functionality and may not be representative of the structure of software, hardware, and/or firmware for implementing the functionality. Accordingly, it should be appreciated that functionality described as being provided by a particular module may, in various embodiments, be provided at least in part by one or more other modules. Further, one or more depicted modules may not be present in certain embodiments, while in other embodiments, additional modules not depicted may be present and may support at least a portion of the described functionality and/or additional functionality. Moreover, while certain modules may be depicted and described as sub-modules of another module, in certain embodiments, such modules may be provided as independent modules or as sub-modules of other modules.

One or more operations of any of the methods 200-400 may be performed by a server 506, by a user device 502, or in a distributed fashion by a server 506 and a user device 502 having the illustrative configuration depicted in FIG. 5, or more specifically, by one or more engines, program modules, applications, or the like executable on such device(s). It should be appreciated, however, that such operations may be implemented in connection with numerous other device configurations.

The operations described and depicted in the illustrative methods of FIGS. 2-4 may be carried out or performed in any suitable order as desired in various example embodiments of the disclosure. Additionally, in certain example embodiments, at least a portion of the operations may be carried out in parallel. Furthermore, in certain example embodiments, less, more, or different operations than those depicted in FIGS. 2-4 may be performed.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure. In addition, it should be appreciated that any operation, element, component, data, or the like described herein as being based on another operation, element, component, data, or the like can be additionally based on one or more other operations, elements, components, data, or the like. Accordingly, the phrase “based on,” or variants thereof, should be interpreted as “based at least in part on.”

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

The present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A computer-implemented method, comprising:
receiving, from a user device, image data indicative of an image of a parts assembly, the image data comprising depth information;
determining a feature representation corresponding to the image data;
determining a pose estimation that matches the feature representation, the pose estimation being a virtual viewpoint of three-dimensional (3D) simulated model data corresponding to the parts assembly;
rendering the pose estimation in association with the image of the parts assembly on a display of the user device; and
utilizing the rendered pose estimation to identify one or more parts of the parts assembly.

2. The computer-implemented method of claim 1, wherein determining a feature representation corresponding to the image data comprises applying a mapping function to the image data to obtain a feature vector comprising a lesser number of feature dimensions than the image data.

3. The computer-implemented method of claim 1, wherein the feature representation is a first feature representation, and wherein determining a pose estimation that matches the first feature representation comprises:
searching a data repository to locate a second feature representation that deviates from the first feature representation by less than a threshold value; and
determining that the pose estimation is stored in the data repository in association with the second feature representation.

4. The computer-implemented method of claim 3, wherein the pose estimation is a first reference pose estimation, the method further comprising:
locating a third feature representation in the data repository that deviates from the first feature representation by less than the threshold value, the third feature representation being associated with a second reference pose estimation;
geometrically mapping each of the first reference pose estimation and the second reference pose estimation to the image of the parts assembly; and
selecting, based at least in part on the geometrically mapping, the first reference pose estimation as the matching pose estimation.

5. The computer-implemented method of claim 1, further comprising:
receiving an indication of a selected portion of the image of the parts assembly; and
determining a portion of the rendered pose estimation that corresponds to the selected portion of the image of the parts assembly,
wherein utilizing the rendered pose estimation to identify the one or more parts of the parts assembly comprises determining a portion of the 3D simulated model data that corresponds to the portion of the rendered pose estimation and identifying the one or more parts using the portion of the 3D simulated model data.

6. The computer-implemented method of claim 5, further comprising displaying respective identifying information for each of the one or more parts in association with a respective location of the part within the selected portion of the image of the parts assembly.

7. The computer-implemented method of claim 6, further comprising receiving, from the user device, an indication of an order of a particular part initiated by user interaction with the respective identifying information of the particular part.

8. A system, comprising:
at least one memory storing computer-executable instructions; and
at least one processor configured to access the at least one memory and execute the computer-executable instructions to:
receive, from a user device, image data indicative of an image of a parts assembly, the image data comprising depth information;
determine a feature representation corresponding to the image data;
determine a pose estimation that matches the feature representation, the pose estimation being a virtual viewpoint of three-dimensional (3D) simulated model data corresponding to the parts assembly;
render the pose estimation in association with the image of the parts assembly on a display of the user device; and
utilize the rendered pose estimation to identify one or more parts of the parts assembly.

9. The system of claim 8, wherein the at least one processor is configured to determine a feature representation corresponding to the image data by executing the computer-executable instructions to apply a mapping function to the image data to obtain a feature vector comprising a lesser number of feature dimensions than the image data.

10. The system of claim 8, wherein the feature representation is a first feature representation, and wherein the at least one processor is configured to determine a pose estimation that matches the first feature representation by executing the computer-executable instructions to:
search a data repository to locate a second feature representation that deviates from the first feature representation by less than a threshold value; and
determine that the pose estimation is stored in the data repository in association with the second feature representation.

11. The system of claim 10, wherein the pose estimation is a first reference pose estimation, and wherein the at least one processor is further configured to execute the computer-executable instructions to:
locate a third feature representation in the data repository that deviates from the first feature representation by less than the threshold value, the third feature representation being associated with a second reference pose estimation;
geometrically map each of the first reference pose estimation and the second reference pose estimation to the image of the parts assembly; and
select, based at least in part on the geometric mapping, the first reference pose estimation as the matching pose estimation.

12. The system of claim 8, wherein the at least one processor is further configured to execute the computer-executable instructions to:
receive an indication of a selected portion of the image of the parts assembly; and
determine a portion of the rendered pose estimation that corresponds to the selected portion of the image of the parts assembly,
wherein the at least one processor is configured to utilize the rendered pose estimation to identify the one or more parts of the parts assembly by executing the computer-executable instructions to determine a portion of the 3D simulated model data that corresponds to the portion of the rendered pose estimation and identify the one or more parts using the portion of the 3D simulated model data.

13. The system of claim 12, wherein the at least one processor is further configured to execute the computer-executable instructions to display respective identifying information for each of the one or more parts in association with a respective location of the part within the selected portion of the image of the parts assembly.

14. The system of claim 13, wherein the at least one processor is further configured to execute the computer-executable instructions to receive, from the user device, an indication of an order of a particular part initiated by user interaction with the respective identifying information of the particular part.

15. A computer program product comprising a storage medium readable by a processing circuit, the storage medium storing instructions executable by the processing circuit to cause the processing circuit to perform the steps of:
receiving, from a user device, image data indicative of an image of a parts assembly, the image data comprising depth information;
determining a feature representation corresponding to the image data;
determining a pose estimation that matches the feature representation, the pose estimation being a virtual viewpoint of three-dimensional (3D) simulated model data corresponding to the parts assembly;
rendering the pose estimation in association with the image of the parts assembly on a display of the user device; and
utilizing the rendered pose estimation to identify one or more parts of the parts assembly.

16. The computer program product of claim 15, wherein determining a feature representation corresponding to the image data comprises applying a mapping function to the image data to obtain a feature vector comprising a lesser number of feature dimensions than the image data.

17. The computer program product of claim 15, wherein the feature representation is a first feature representation, and wherein determining a pose estimation that matches the first feature representation comprises:
searching a data repository to locate a second feature representation that deviates from the first feature representation by less than a threshold value; and
determining that the pose estimation is stored in the data repository in association with the second feature representation.

18. The computer program product of claim 15, the method further comprising:
receiving an indication of a selected portion of the image of the parts assembly; and
determining a portion of the rendered pose estimation that corresponds to the selected portion of the image of the parts assembly,
wherein utilizing the rendered pose estimation to identify the one or more parts of the parts assembly comprises determining a portion of the 3D simulated model data that corresponds to the portion of the rendered pose estimation and identifying the one or more parts using the portion of the 3D simulated model data.

19. The computer program product of claim 18, the method further comprising displaying respective identifying information for each of the one or more parts in association with a respective location of the part within the selected portion of the image of the parts assembly.

20. The computer program product of claim 19, the method further comprising receiving, from the user device, an indication of an order of a particular part initiated by user interaction with the respective identifying information of the particular part.
